(19) United States
(12) Patent Application Publication
(10) Pub. No.: US 2012/0017548 A1
(43) Pub. Date: Jan. 26, 2012

(54) SUSPENSION SADDLE

(76) Inventor: Valentina BAIO, Bethlehem, PA (US)

(21) Appl. No.: 13/173,704

(22) Filed: Jun. 30, 2011

Related U.S. Application Data
(60) Provisional application No. 61/367,618, filed on Jul. 26, 2010.

(51) Int. Cl. B68C 1/10

(52) U.S. Cl. 54/44.4

(57) ABSTRACT

Disclosed is a suspension saddle to be used in equestrian and other uses, similar to traditional saddle use. The suspension saddle includes a base portion interconnected to a seat portion by a suspension system for permitting substantially vertical movement of the seat portion with respect to the base portion.

### CROSS-REFERENCE TO RELATED APPLICATIONS

This application claims priority to U.S. provisional application Ser. No. 61/367,618 filed Jul. 26, 2010, which is incorporated herein by reference in its entirety.

### TECHNOLOGY FIELD

The present invention relates to saddles. More particularly, the invention relates to saddles provided with a suspension system. Even more particular, embodiments of the invention relates to equestrian saddles having a suspension system between a base portion and a seat portion.

### BACKGROUND

Saddles are used to help hold a rider in place, distribute the rider's weight more evenly, and to protect the spine of the animal ridden. Although saddles are most common for equestrian uses, saddles for other animals have also been made, such as for camels, lamas, elephants, and the like. This discussion will focus on the equestrian saddle, although it is applicable to any saddle.

Traditionally, a saddle is built around a saddle tree, with layers of leather and/or other materials put in place for functional and decorative attributes. The saddle tree is the structure lending rigidity to the saddle. The tree distributes the rider's weight to avoid undue stress and pressure to the horse's spine. It is customary that a skirt be provided between the horse and the tree. This is usually leather and may or may not have some kind of stuffing or padding material. The skirt and its padding are intended to reduce discomfort experienced by the horse from the saddle. The seat of the saddle is built on top of the tree. Through various techniques, the seat is built up on the tree to provide some level of comfort and security for the rider. A cantle at the rear of the seat provides some resistance to prevent the rider from sliding off the back of the saddle. Traditionally, a saddle is made as essentially a single unit, with the seat built upon and fused to the saddle tree.

Ideally, a saddle is unique to the rider/horse combination, taking into account the size and shape of the horse, as well as the rider. Most saddles are provided with an arch raising a medial portion of the saddle off of the horse's spine, thereby distributing the rider's weight away from the horse's spine. The saddle otherwise remains essentially in full contact with the horse's back, and receives the full brunt of the rider's weight, unless the rider is capable of supporting his or her own weight in the stirrups. This is unlikely in inexperienced riders, elderly riders, or disabled riders, and in other situations. As a result, the horse supports not only the rider's full weight, but also the additional forces created from cantering, trotting, jumping, galloping, and even walking. When a rider is unable to absorb the forces with their legs, the horse, and particularly the horse's back and spine suffer the assault. This can be uncomfortable for the rider and the horse and potentially damaging to the horse. Continued assault can shorten the length of rides, require extended recovery time for the horse, or eventually reduce the riding life of the horse.

There is a need to minimize these and other affects, to protect horses, improve rider comfort, compensate for a rider's inexperience, and to improve upon saddles and saddle making techniques.

### SUMMARY

In some embodiments, the invention provides a suspension saddle comprising a seat portion and a base portion, wherein the seat portion is affixed to the base portion for independent movement with respect thereto.

In some embodiments, the seat portion is affixed to the base portion for independent, substantially vertical movement with respect to the base portion, while substantially fixed with respect to lateral movement.

In some embodiments, the saddle includes a suspension system disposed between and connecting the seat portion and the base portion. In some embodiments, the suspension system comprises a plurality of shock absorbers interconnecting the seat portion and the base portion. The shock absorbers may be any suitable shock absorber including those selected from springs, mechanical arms, flexures, hydraulic pistons, and combinations thereof.

Some embodiments of the invention provide a saddle comprising a seat portion having a front and a rear; a base portion comprising a front arch support; a rear arch support; a suspension system comprising a front suspension system affixing the front arch support to the front of the seat portion; a rear suspension system affixing the rear arch support to the rear of the seat portion, wherein the seat portion is affixed to the base portion via the suspension system for movement in substantially a vertical direction.

Some embodiments further provide that the rear suspension system further comprises a plurality of laterally disposed mechanical arms permitting movement of the seat portion in substantially a vertical direction. In some embodiments, the mechanical arms are spring loaded.

Some embodiments of the invention further provide a front seat support arm affixed to the seat portion; a shock absorber connected at a lower end to the front arch support and at an upper end to the front seat support arm; wherein the front seat support arm and the seat portion are permitted to move only in a substantially vertical direction.

Some embodiments of the invention further provide a front seat support arm affixed to the seat portion; wherein the rear suspension system comprises a plurality of laterally disposed spring-loaded mechanical arms permitting movement of the seat portion in substantially a vertical direction; and wherein the front suspension system comprises a shock absorber connected at a lower end to the front arch support and at an upper end to the front seat support arm, wherein the front seat support arm and the seat portion are permitted to move only in a substantially vertical direction.

Some embodiments of the invention provide a suspension saddle comprising a base portion, a seat portion, and a suspension system between and interconnecting the base portion and the seat portion.

Some embodiments further provide a base portion defining an upper surface; a seat portion defining an upper surface for a seat and a lower surface facing the upper surface of the base portion; a suspension system comprising a plurality of shock absorbers extending between and affixed to the lower surface of the seat portion and the upper surface of the base portion.

In some embodiments, the shock absorbers are selected from springs, mechanical arms, flexures, hydraulic pistons, and combinations thereof.

In some embodiments, the suspension system is tuned to about 100 lbf/inch (slugs/inch) to about 500 lbf/inch (slugs/inch).

In some embodiments, the suspension system is tuned to accommodate a force of about 1.5 to about 3 times the rider's estimated weight. In some embodiments, the suspension system is tuned to a slugs/inch of 96 to 258 times the riders estimated weight. These numbers correspond to forces of about 3G to about 8G, where G is gravitational acceleration (32.2 ft/s²).

In some embodiments, the suspension system comprises a plurality of compression springs and dampers capable of supporting the seat portion and a rider for independent movement, in a substantially vertical direction, with respect to the top of the base portion.

In some embodiments, the seat portion is supported for independent movement above the base portion by at least three compression springs arranged and positioned for substantially vertical movement.

In some embodiments, the invention employs a plurality of compression springs arranged substantially evenly along the top surface of the base portion to support the seat portion. In further embodiments, each of the base portion and seat portion define a central longitudinal arch and the plurality of compression springs are disposed symmetrically about the central arch.

Some embodiments of the invention employ a suspension system comprising a plurality of laterally disposed flexure arms supporting the seat portion above the base portion for vertical movement with respect thereto. In some embodiments, the plurality of laterally disposed flexure arms is affixed to the base portion, and moveably affixed to the seat portion to facilitate movement of the seat portion with respect to the base portion. In further embodiments, each of the base portion and seat portion define a central longitudinal arch and the plurality of flexure arms are disposed symmetrically about the central arch.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1A is an exploded perspective view of one embodiment of the invention from the front/side;

FIG. 1B is an exploded perspective view of the embodiment FIG. 1A, viewed from front/bottom/side;

FIG. 1C is an exploded perspective view of the embodiment FIG. 1A, viewed from the front/bottom;

FIG. 1D is an exploded rear view of the embodiment FIG. 1A, viewed from the rear;

FIG. 2A is an exploded perspective view of one embodiment of the invention from the front/side;

FIG. 2B is an exploded perspective view of the embodiment FIG. 2A, viewed from front/bottom/side;

FIG. 2C is an exploded perspective view of the embodiment FIG. 2A, viewed from the front/bottom;

FIG. 2D is an exploded rear view of the embodiment FIG. 2A, viewed from the rear;

FIG. 3A is a perspective view of one embodiment of the invention;

FIG. 3B is a side elevational view of the embodiment FIG. 3A; and

FIG. 3C is a rear elevational view of the embodiment FIG. 3A.

### DETAILED DESCRIPTION

This detailed description focuses on equestrian suspension saddles, but the invention applies to all types of saddles and is not intended to be limited to use with horses.

To alleviate the force created by the rider when walking, trotting, cantering, jumping, etc., a saddle with a suspension system (hereinafter “suspension saddle”) allowing for independent movement of a seat portion of the suspension saddle with respect to a base portion of the suspension saddle is disclosed herein. The suspension system can be incorporated into a traditional saddle with perhaps a perceptible difference in saddle height. Also, the suspension system may be incorporated in to new saddles during original manufacturing. The resulting suspension saddle is particularly well suited for use with inexperienced riders, older horses, endurance riders, and others. The suspension saddle provides additional protection to the horse's spine by absorbing some of the forces created by the rider during a ride.

Inexperienced riders often are not in synch with the horse, often collapsing their full weight into the saddle to the horse. This can be uncomfortable for the horse, and possibly result in spinal damage to the horse. In some cases, the rider may also experience discomfort or even be thrown off-balance creating the potential danger of falling off the horse. Some embodiments of a suspension saddle of the invention could prolong the riding life of an aging horse, by protecting them from unabated assault on their spines.

Similarly, riders such as elderly, injured, disabled riders, or those who simply cannot use their legs to absorb some of these forces, can benefit from the suspension saddles disclosed herein. The suspension saddle makes the ride more comfortable and therefore more enjoyable to the rider. Therapeutic riding would be enhanced by facilitating longer ride times for either or both of the rider and the horse.

Embodiments of the invention provide a suspension saddle useful in making saddles particularly for equestrian use. Some suspension saddles according to the invention may be made with traditional saddle appearances, and without noticeable aesthetic differences. In other embodiments, the suspension saddles disclosed herein can take on new shapes, uses, and approaches as a result of the flexibility of the design. Many traditional saddle styles, including the Western and English styles, may include a suspension system. Although the suspension saddle is well-suited for use in newly constructed suspension saddles, an existing saddle could be retrofitted to include a suspension system to take advantage of the techniques disclosed herein.

As with existing saddles, some suspension saddles in accordance with the invention may be covered by various materials to achieve the final suspension saddle. Traditional materials include leather and padding materials. Additional materials may include, but are not limited to, leather, leather substitutes, plastics, nylon, fabrics, canvas, etc. Traditional saddle making techniques may be used in making a suspension saddle disclosed herein.

Generally, some suspension saddles in accordance with the invention comprise a seat portion and a base portion, interconnected and spaced apart by a suspension system.

The base portion is the portion that makes contact with the horse. The base portion is responsible for distributing a rider's weight across the horse's back and, preferably, bridging the horse's spine so as to avoid putting direct pressure on the spine. The base portion defines a horse-side lower surface and an upper surface. Ideally, the base portion, particularly the lower surface, is fitted specifically to the size, shape and curves of a particular horse so as to facilitate the ultimate fit, comfort, and support. Saddle trees have traditionally been made of light-weight but strong wood. Wood has gone out of favor due to its poor fatigue and weather resistance; metal, plastics, and composite materials have become more popular in recent times. These traditional and popular materials can be used for the base portion of the suspension saddle of the invention. Newer materials such as plastics, fiberglass, carbon fiber, etc. may also be used. Combinations of the newer materials and/or more traditional materials may also be used. The use of newer materials may result in several advantages, including lighter weight, higher strength, greater flexibility, ease of manufacture, etc.

The seat portion is the portion that supports the rider. The seat portion can either define a seat or have a seat built thereupon, depending upon the saddle design. The seat portion is designed with the rider and the horse in mind, in accordance with traditional saddle making techniques. As with the base portion, the seat portion can be made from traditional materials such as metals, wood, newer materials, such as plastics, fiberglass, carbon fiber, etc. or combinations of these and then covered with padding and aesthetic material to create a finished seat. In some embodiments, the seat portion of the suspension system and the seat of the saddle are a singular construction.

To accommodate the horse's spine, at least the base portion can be provided with a medial arch running along the length of the base portion. In some embodiments, this arch is substantially mirrored in the seat portion. Because the seat portion is supported above the base portion, the arch can be less pronounced, and the portion approximating the seat location can be made to be flatter to facilitate formation of the seat itself.

A suspension system is used to elevate the seat portion above the base portion thus defining a gap or clearance there between. As such, the suspension system connecting the base portion and seat portion results in a spaced-apart relation to one another. The suspension system allows for vertical movement of the seat portion, allowing the system to absorb all or a portion of the rise and fall of the rider, thereby saving the horse (and rider) from some of the pounding that can be experienced during a ride, particularly with inexperienced riders or riders who lack muscle strength or coordination for riding. The suspension system interconnects the seat portion and the base portion of the suspension saddle for substantially independent vertical movement of the seat portion with respect to the base portion. In some embodiments, the movement of the seat portion is limited to a substantially vertical movement.

The term “vertical movement” and similar terms as used herein refers to the movement of the seat portion with respect to normal riding position of the saddle, which is generally horizontal. The “vertical movement” is generally perpendicular to the saddle and the horse's back.

The amount of support or give in the suspension system can be selected with the specific rider and horse in mind as well as the style of riding. In some embodiments, the suspension system is tuned to about 100 lbf/in to about 300 lbf/in or slug/in. In some embodiments, the suspension system is tuned to about 250 lbf/in to about 500 lbf/in or slug/in. In some embodiments, the suspension system is chosen as a function of the rider's weight, with heavier riders usually requiring greater support. In some embodiments, the suspension system is tuned to about 96 to about 258 times the rider's weight.

The activity of the rider may also be taken into account. An active rider will, in many cases, use his or her legs to absorb some of the up and down movement experienced in a ride, thus relieving the horse from direct pressure on its back. A suspension saddle in accordance with this invention will further cushion the ride. In some instances, however, such as in a therapeutic situation, the rider is incapable of supporting his or her own weight and the horse takes the full brunt of the rider's weight with every movement. In these situations, a suspension saddle in accordance with the invention could be tuned to absorb a larger portion of the rider's weight, thereby easing the ride for both rider and horse. More experienced riders, could adjust their saddles for more “feel” if desired. The adjustment may be made during original manufacture, repair, or as by a manual adjustment means provided on the suspension saddle.

In some embodiments, the suspension system may be tuned based upon the calculated or measured forces generated by the rider in the seat. For example, some riders may generate about 3G while others may generate 8G in the saddle. To soften the effect of this on both horse and rider, the suspension system can be adjusted either during fabrication or with a manual adjustment means. Adjustment of the suspension system may be accomplished, for example, by adjusting the spring stiffness and damping rate.

In some embodiments, the system may be tuned to provide a specific level of support during initial manufacture or during a repair. In other embodiments a manual adjustment means can be provided so the rider can manually adjust the stiffness in the suspension system. For example, in some embodiments, a ratchet, dial or lever can be provided for adjusting the suspension system allowing a range of support. In these embodiments, a single suspension saddle can be manually tuned as the rider or the horse's needs change without the need for sending the suspension saddle out for repairs or adjustment.

Movement of the seat portion in a lateral direction is undesirable. If the seat portion were allowed to move in a forward/rearward direction, it could actually facilitate the throwing of the rider. If the horse were to start suddenly, a rearward moving seat portion would potentially aid in allowing the rider to slide backwards off the horse. In contrast, a forward moving seat portion would result from a sudden stop, and could help propel the rider over the horse's head. Neither situation is desirable. Instead, the suspension saddle is preferably designed to facilitate keeping the rider in the seat, by limiting motion in a lateral direction, while allowing the seat to move up and down with the rider.

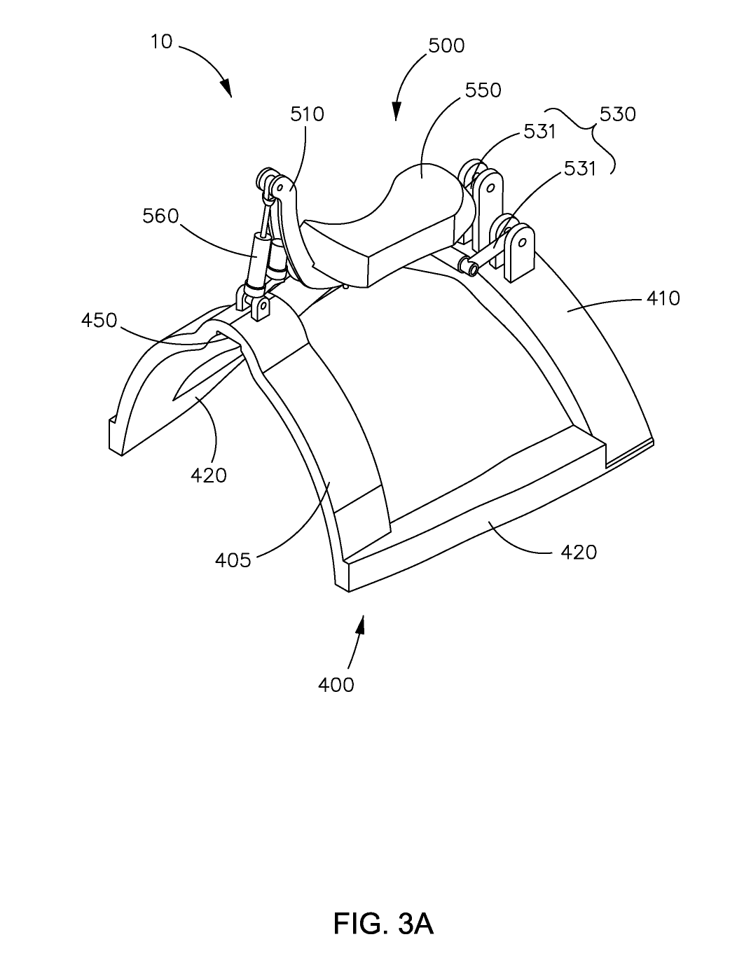

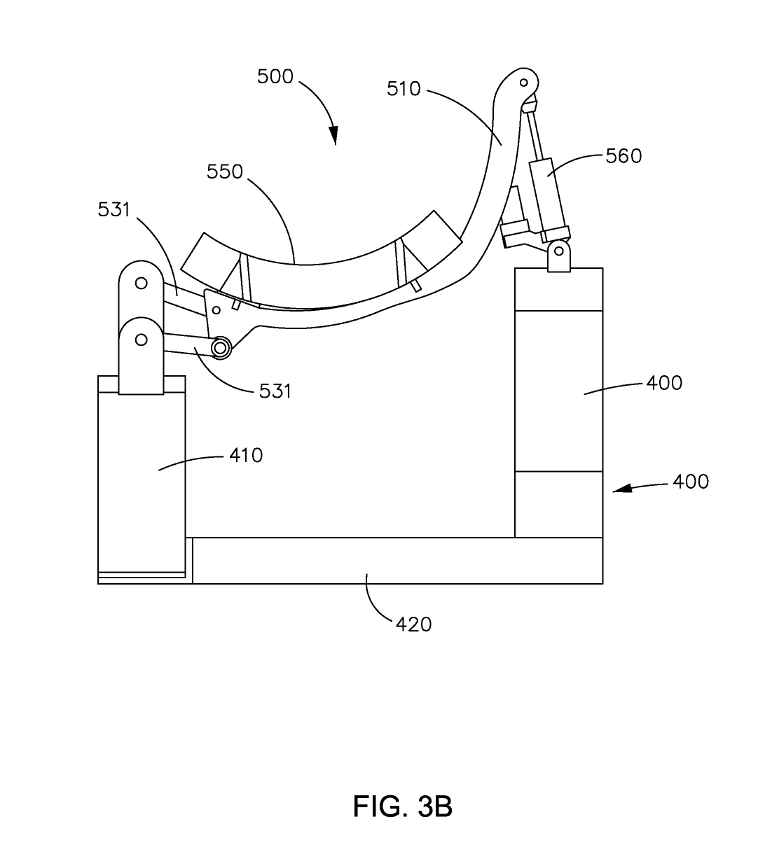

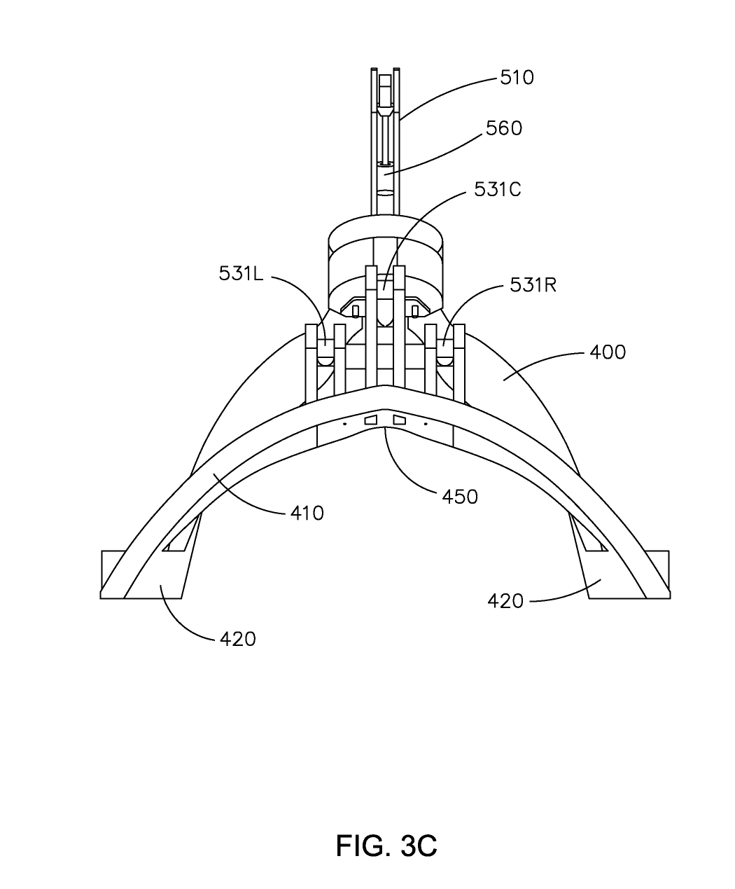

The suspension system maintains a gap between the seat portion and the base portion of the suspension saddle, and ultimately (or indirectly) between the seat portion and the horse's back. Preferably, the suspension system also minimizes, if not eliminates, the likelihood that the seat portion will contact the base portion or the horse's back. In some embodiments, see e.g. FIGS. 3A-3C, the gap is maintained with respect to the horse's back. The suspension system allows for movement towards and away from the base portion or the horse's back. It is foreseeable that in some instances, the suspension system may allow downward movement such that the rider “bottoms out” with the gap being reduced essentially to zero. Such circumstances should be rare. Even in such extreme circumstances, the suspension system will have served its purpose, since the suspension system will have absorbed at least some of the forces involved. Without the suspension saddle, much more force would be applied directly to the horse. The gap can be defined in several ways. The gap without a rider will depend upon a number of factors, including the suspension system tuning, the anticipated weight and skill of the rider, etc. Typically, the mean gap without a rider will be from about 1.0 inches to about 5.0 inches. With rider in place, and no movement, the suspension system is tuned such that the gap is preferably about 0.5 inches to about 4.0 inches. This of course, may vary depending on intended use, evidencing the usefulness of a manually adjustable suspension system. During a ride, the suspension system should maintain the gap between about 0.5 inch and 4.0 inches, with the goal of minimizing or eliminating the occurrences of “bottoming out.” Maintaining this level of gap ensures the dual purposes of improving the ride for the horse and the rider.

The suspension saddle may be covered by traditional or other saddling techniques. To allow the movement of the seat portion with respect to the base portion, the two sections (i.e., the base portion and the seat portion) must remain independent (i.e., they are allowed to move relative to one another). The gap between the two may be left exposed or covered. If for aesthetic purposes it is desired to cover the gap, this can be accomplished in several ways. One simple way would be to have a material flap or skirt extend from the seat portion over the base portion. Such a flap could be unattached at the base portion, allowing the flap to move freely up and down along with the seat portion. This arrangement also benefits from easier access to the suspension system should adjustment or repair be required. If the covering must be secured to both the seat portion and the base portion, a flexible material can be used, or an expandable gusset could be provided to allow for a full range of movement. The materials and techniques to accomplish these and other possible solutions should be well known to those of skill in the art.

As noted previously, saddle construction ideally is specific to the rider and the horse. Employing a suspension saddle as described herein allows for easy customization of a suspension system to accommodate rider changes as well as horse changes. For example, some embodiments of the invention may allow for complete interchangeability of the seat portion. For example, a riding academy with three horses, but many riders, to facilitate the best fit, comfort and safety for each horse, would need for each horse, a saddle to accommodate various sized riders, from child to adult, say a small medium and large for each horse. With the suspension saddle disclosed herein, the academy could fit a single base portion to each of its horses, providing the ultimate fit and comfort for each horse. A plurality of seat portions could be maintained to accommodate riders from small children to experienced adults, thus adapting the seat portion to the rider. The suspension system could likewise be adjusted depending on the rider and/or horse. In this example, a single horse is fitted with a base portion specific to that horse. Thus, instead of forcing riders of different sizes and skill sets into using the same saddle, the seat portion could readily be exchanged between rides. A safe, comfortable ride for the horse and rider results while minimizing the need for multiple saddles.

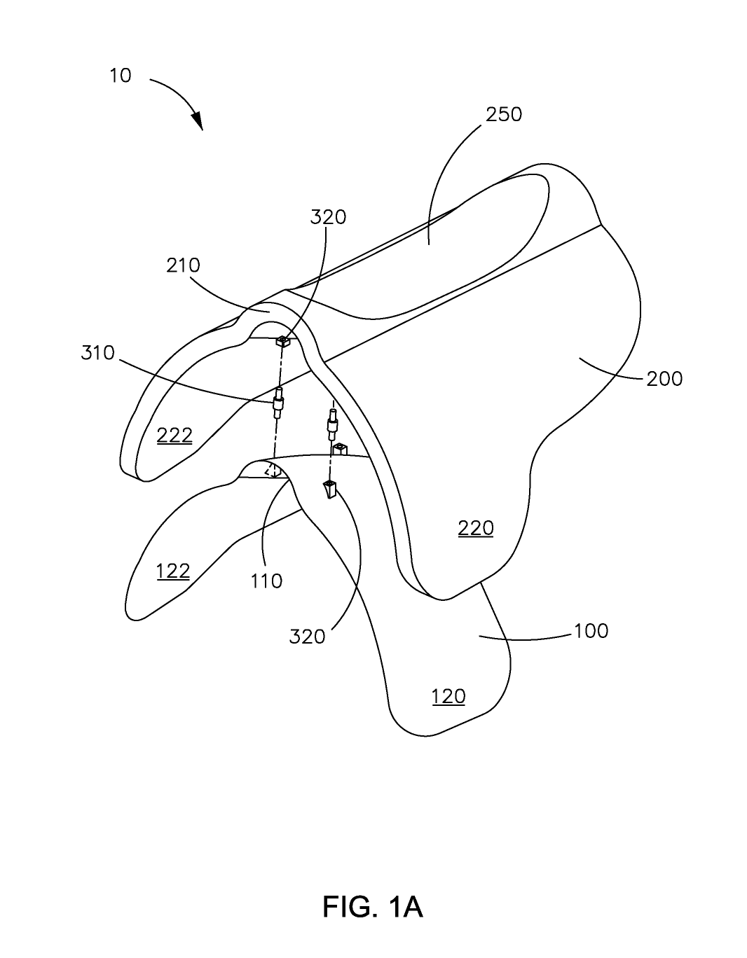

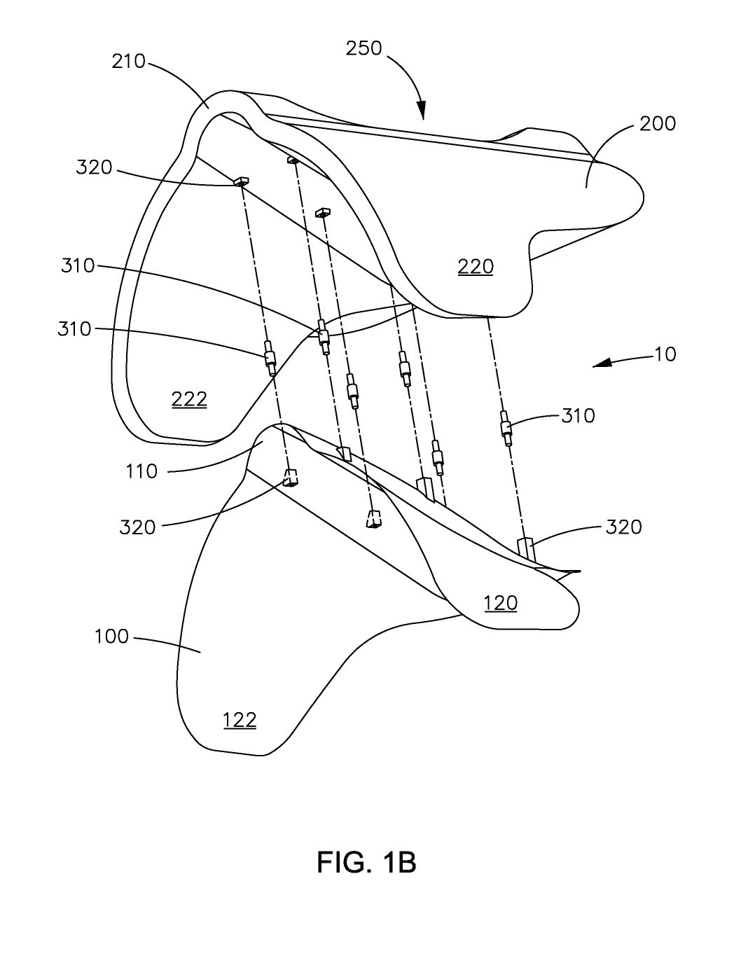

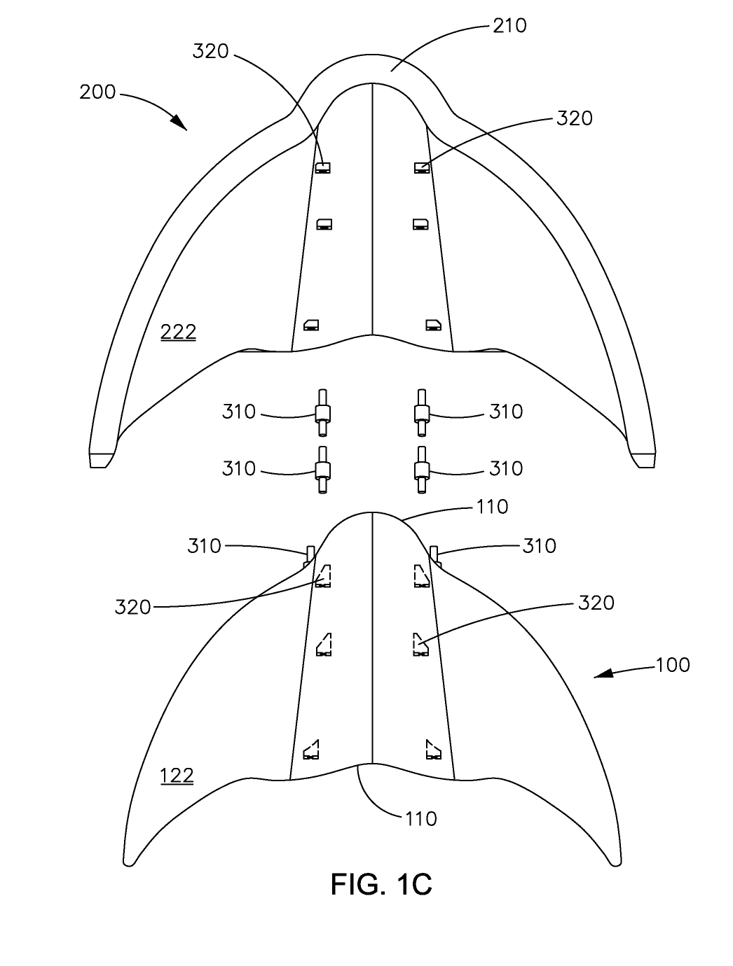

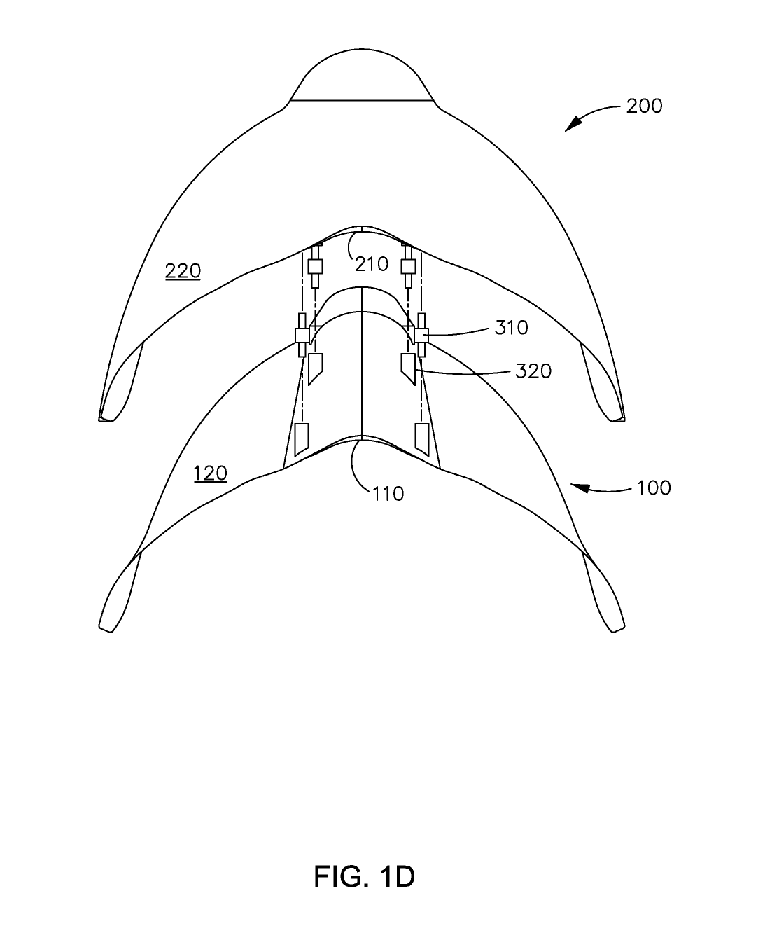

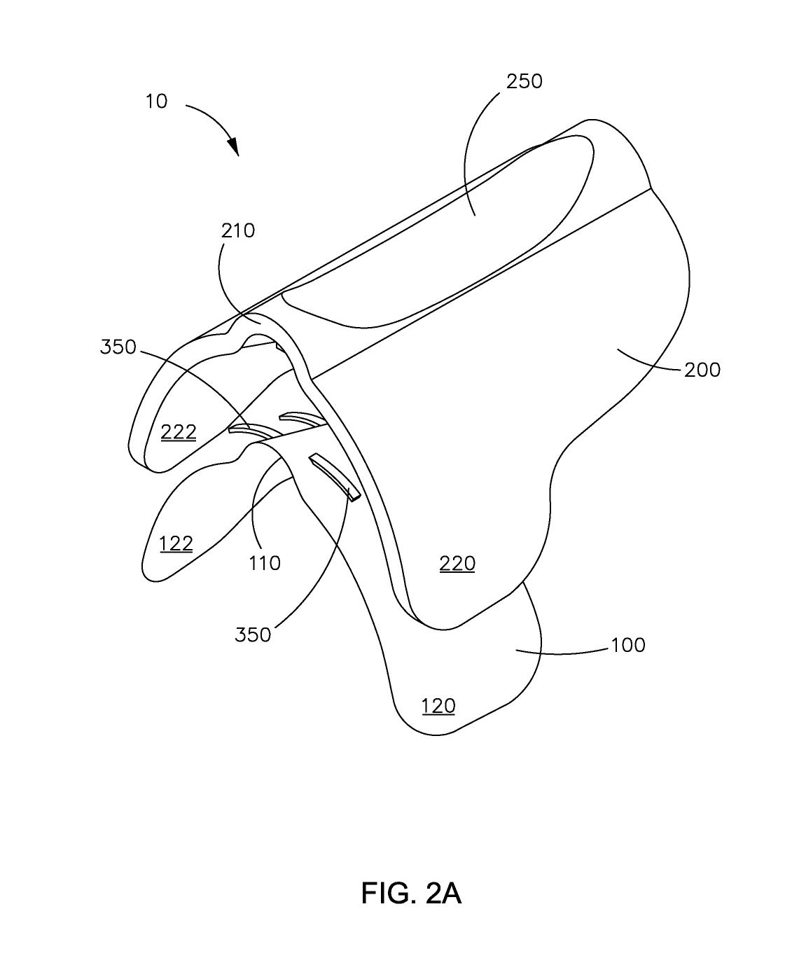

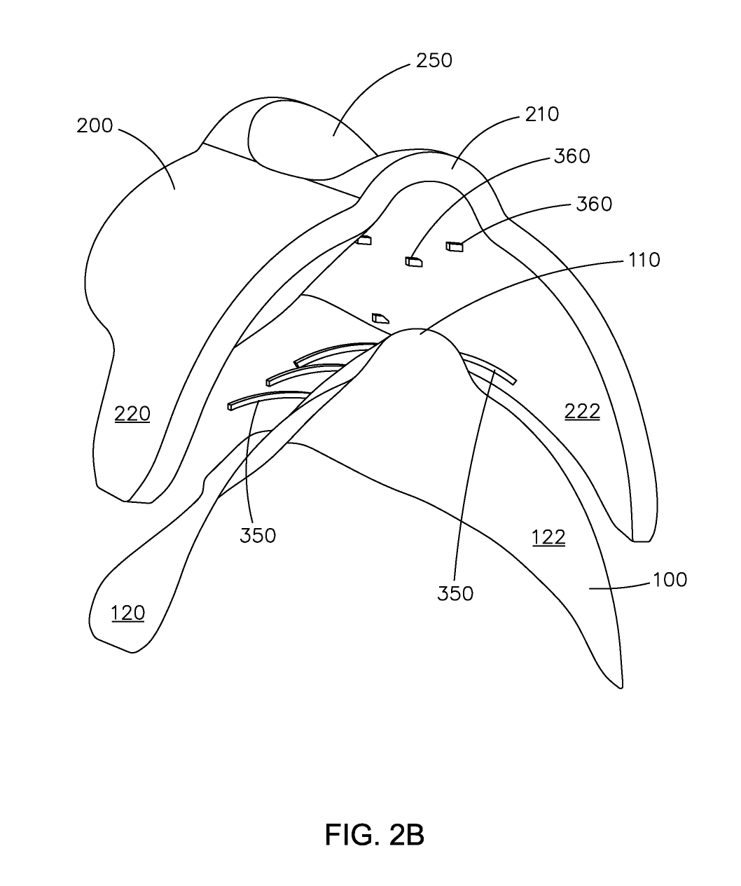

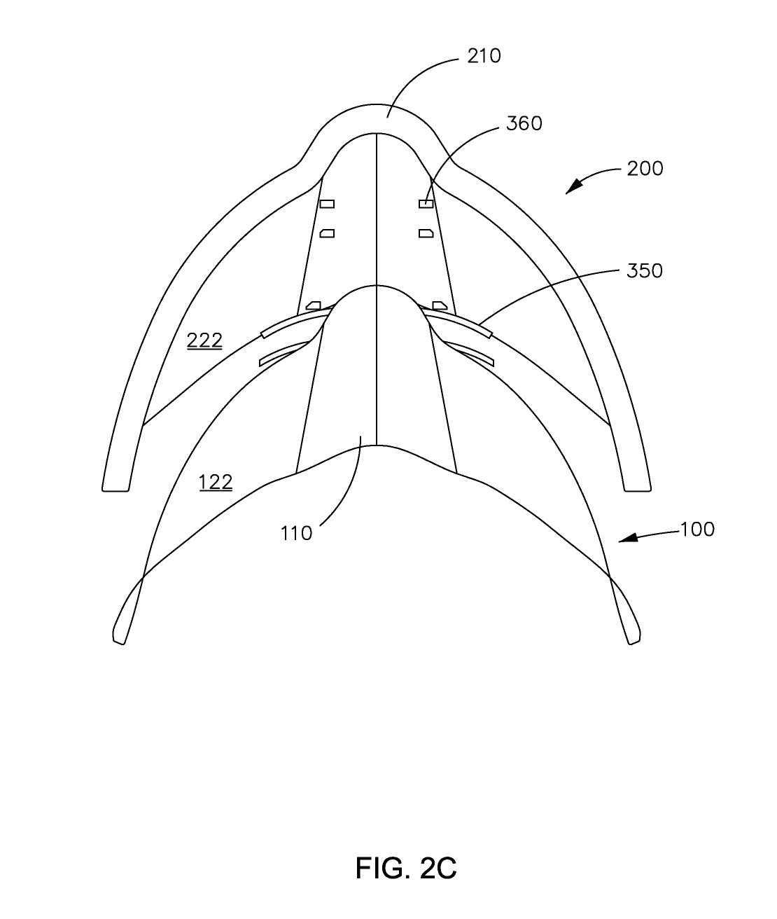

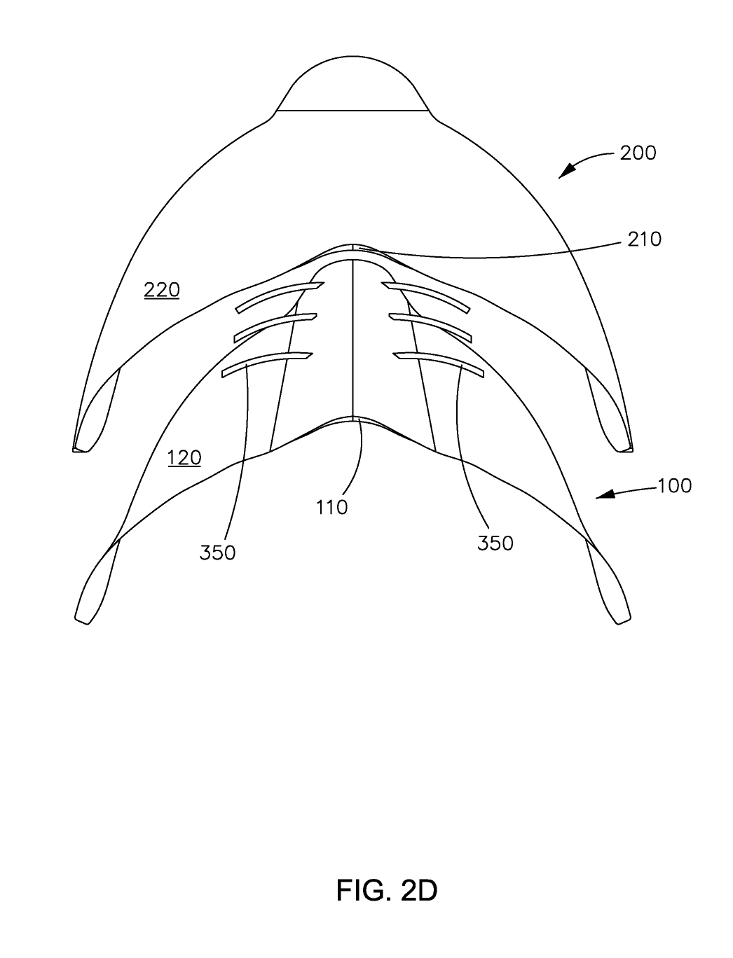

Referring to the figures, each shows a suspension saddle in accordance with the invention. As should be readily understood, the suspension saddles may be dressed and finished using traditional, or non-traditional, saddle making materials and techniques. The resulting saddle is a suspension saddle in accordance with the invention. A traditionally finished saddle is not depicted, although it should be noted that some of the suspension saddles could forego the finishing process and be used in a bare state. For example the embodiments of FIGS. 1A-1D, and FIGS. 2A-2D could be used without further finishing or embellishment, particularly when constructed of a material such as carbon fiber or polycarbonate.

With reference to FIGS. 1A-1D, one embodiment of the suspension saddle 10 of the invention is shown. As can be seen, a base portion 100 is provided. A medial, longitudinally extending arch 110 is provided for alignment with the horse's spine. The base portion 100 defines a lower surface 122 which ultimately engages the horse's back and an upper surface 120 which faces the seat portion 200 of the suspension saddle.

The seat portion 200 of the suspension saddle, as shown, includes a well defined medial longitudinally extending arch 210 complimentary to the arch 110 found in the base portion 100. A flattened section 250 is provided corresponding to the portion where the seat will be located. A lower surface 222 which faces the base portion 100 is defined, as is an upper surface 220 which ultimately engages the rider.

The suspension system 300 employed in FIGS. 1A-1D is a compression spring based suspension system. A plurality of compression springs 310 interconnect the upper surface 120 of the base portion 100 to the lower surface 222 of the seat portion 200. As depicted, each of the seat portion 200 and the base portion 100 are provided with a plurality of attachment points 320 equal to the number of springs 310. Each spring 310 is affixed to the base and seat portions (100, 200) of the suspension saddle. In some embodiments, the springs 310 may be permanently affixed. In other embodiments, the springs 310 may be removably affixed so that they may be changed for any reason, including routine maintenance of the saddle, increasing or decreasing the strength of the spring as a result of any of several factors, such as weight change in the rider, change in experience level of the rider, age or the horse, length or intensity of the ride, etc. A means of permanently or removably affixing the springs, such as threaded engagements, frictional fitting adhesives, pins, etc., can be employed. FIGS. 1A-1D depict a threaded arrangement.

As seen particularly in FIG. 1C, this embodiment has six compression springs 310 located symmetrically about the medial arch 110, 210. The number and location of springs may change or vary so long as they are capable of supporting the rider's weight and suspending the rider and seat above the horse's back and the base portion 200 of the suspension saddle for vertical movement with respect thereto.

A sufficient number of springs and/or their placement is designed to maintain a gap or clearance between the base and seat portions (100, 200). The suspension system is preferably designed to prevent or substantially avoid any bottoming out of the suspension system.

Although embodiments employing two springs can be envisioned, it is believed that at least three springs, one of which is in line with the medial arch 110, 210 while the remaining two are symmetrically disposed about the arch, would facilitate vertical movement while limiting lateral movement. This triangular arrangement coupled with proper spring choice and positioning is believed to minimize lateral movement in a system employing only three springs. When more than three springs are used, a medially placed spring is not needed, although one or more such springs could be used. Regardless of the number of springs, each spring is positioned and located such that its movement is substantially restricted to the vertical direction.

The design shown is particularly well-suited to the English saddle style, but could easily be adapted to include the characteristics of a Western saddle or other style. In this particular style, the seat portion 200 actually defines the seat 250 as well. The suspension saddle can be wrapped in leather or other suitable materials as discussed above, to produce a finished saddle, provided the seat portion is moveable with respect to the base portion. Other saddle parts such as the seat, cantle, etc. can be made as in traditional techniques. The stirrups may be attached to either the base portion or the seat portion and may be determined as a matter of rider comfort or choice. Where the stirrups are affixed to the base portion of the suspension saddle the rider may support some of his or her own weight, without relying on the suspension saddle. To properly secure the suspension saddle to the horse, the girth or cinch should be secured to the base portion or to the materials wrapped on the base portion. It is preferable that these not be attached to the seat portion as once the girth is secured under the horse's barrel, movement of the seat would be highly restricted or the suspension saddle might be not be firmly held in place.

FIGS. 2A-2D depict an alternative embodiment similar to that described above. In this embodiment, the suspension system comprises a plurality of flexure arms 350 disposed symmetrically about the medial arch 110. As depicted, each flexure arm 350 is affixed to the base portion 100 of the saddle. The flexure arm 350 can be permanently or removably fixed to the base portion 100. In the embodiment shown each flexure arm 350 is moveable affixed to the lower surface 222 of the seat portion 200 of the suspension saddle. To facilitate movement of the seat portion 200, each flexure arm 350 slides along the lower surface 222 of the seat portion 200. To prevent the seat portion 200 from moving laterally, a series of engagement means 360 are provided for each flexure arm 350. As shown, a clip or series of clips can be provided which engage the flexure arm 350, but allow it to slide within the clip(s) with the rise and fall of the seat portion 200 thereby allowing the seat to move vertically supported by the flexure arms 350. Separate stops (not shown) may be used to prevent or limited lateral movement between the seat portion and the base portion. It should be noted, that the reverse arrangement, and others, are also permitted, so long as the seat portion 200 of the saddle is substantially limited to vertical movement with respect to the base portion 100.

As described above, the saddle may be finished in accordance with saddle making techniques.

Although FIGS. 1A-1D and 2A-2D depict two specific suspension systems, any suitable suspension system can be used, including a combination of one or more different types. Suitable suspension systems include shock absorbers, springs such as but not limited to compression springs, leaf springs, volute springs, etc., flexure arms (or cantilever springs), hydraulic or gas pistons and cylinders, etc. All systems described herein may be damped or undamped.

FIGS. 3A-3C depict another embodiment of the invention. This design is particularly well-suited for Western style saddles or other types that have a raised pommel or horn. The suspension saddle again has a base portion 400 and a saddle portion 500 and a suspension system supporting the seat portion 500 above the base portion 400 and the horse's back.

The base portion 400 is defined by a front arch 405 and a rear arch 410, each preferably defining a medial arch 450 to raise support off of the horse's spine. The front arch 405 and rear arch 410 are design to distribute the rider's weight away from the horse's spine. The front arch 405 and rear arch 410 may optionally be interconnected by a connective strap 420 which prevents the arches from moving away from each other. The base portion can be made from any suitable material such as metal, wood, plastic, fiberglass, carbon fiber, etc., as can the connective strap. The connective strap 420, however, need only prevent the front and rear arches from pushing apart, and thus could be a much lighter material, such as leather, fabric, nylon, etc., but can still be made of metal, composites, etc.

As depicted the seat portion 500 has a front and a rear interconnected by a flattened portion 550 whereupon the seat is built. In this embodiment, the front defines a gooseneck 510 which at its lower end becomes the seat 550 and at its upper end is affixed to a front suspension member 560. The rear of the seat is affixed to at least one rear suspension member 530.

The front suspension member 560 interconnects the gooseneck portion 510 of the seat portion of the saddle to the front arch 405 of the base portion of the saddle. As shown, a shock absorber, which can be essentially a cylinder and piston with or without a compression/expansion spring, is used. In this arrangement, the shock absorber allows the front end of the seat portion to rise and fall while being supported above the horse's back and above the base portion.

The rear suspension member 530 interconnects the rear seat portion to the rear arch 410 of the base portion of the saddle. As depicted, a three-part suspension system can be used. As shown, three lever arms 531 connect in right, left, and central positions to the rear of the seat portion (showing FIG. 3C as 531R, 531C, and 531L, respectively). Each lever arm 531 is connected to the rear arch 410 of the base portion of the saddle for rotation about a perpendicularly disposed axis. The opposite end of each lever arm 531 is rotatably affixed to the rear of the seat portion of the saddle. Employing this system limits lateral movement while allowing independent movement of the seat portion in a substantially vertical direction with respect to the base portion. In some embodiments, one or more lever arms may be spring-loaded.

In an alternative embodiment not shown, a scissor linkage may be used, whereby the front of the seat portion is connected via a scissor arm to the rear portion of the base, and the rear portion of the seat is connect via another scissor arm to the front of the base portion. One or both scissor arms are permitted to slide on either or both of the seat portion or base portion, which results in raising or lowering the seat, while stabilizing the seat against lateral movement. A spring or other means is provided and can be tuned as described above to provide the right amount of support to keep the seat and rider elevated above the base portion and horse's back.

The suspension saddle 10 may be covered with traditional or untraditional materials and techniques. In this particular embodiment, the horn or pommel may be made around the gooseneck portion 510 of the seat portion of the saddle. Again, care should be taken to ensure the seat portion can move with respect to the base. As with the prior embodiments, the gap can be covered by any suitable means, including but not limited to a flap, an expandable material, or an expandable gusset.

Suspension saddles disclosed herein can be made to resemble traditional saddles or to be completely new forms.

The suspension systems contemplated herein can be permanent, removable, and/or adjustable. For example, as a rider or horse's needs change, an adjustable system would allow the rider to select the amount of give in the suspension system so a tighter or looser ride can be achieved. Similar adjustments can be achieved through the use of removable and interchangeable systems, such as replacing springs with stiffer versions.

The best saddles are fit to both the horse and the rider, and therefore are highly customized pieces of equipment.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A suspension saddle comprising:
a seat portion;
a base portion, and
a suspension system disposed between said seat portion and said base portion for independent movement of said seat portion with respect to said base portion.

2. The suspension saddle of claim 1, wherein said suspension system maintains a gap between said seat portion and said base portion.

3. The suspension saddle of claim 1, wherein said seat portion is affixed to said base portion for independent, substantially vertical movement with respect to said base portion, while substantially fixed with respect to lateral movement.

4. The suspension saddle of claim 1, wherein said suspension saddle is further provided with a plurality of shock absorbers interconnecting said seat portion and said base portion.

5. The suspension saddle of claim 4 wherein said shock absorbers are selected from springs, mechanical arms, flexures, hydraulic pistons, and combinations thereof.

6. A suspension saddle comprising:
a seat portion having a front and a rear;
a base portion further comprising:
a front arch support;
a rear arch support;
and a suspension system;
wherein said seat portion is affixed to said base portion via said suspension system for movement in substantially the vertical axis.

7. The suspension saddle of claim 6, wherein said suspension system further comprises:
a front suspension system affixing said front arch support to said front of said seat portion;
a rear suspension system affixing said rear arch support to said rear of said seat portion.

8. The suspension saddle of claim 6, wherein said suspension system further comprises:
first and second scissor arms, each affixed at opposite ends to said seat portion and said base portion.

9. The suspension saddle of claim 6, wherein said rear suspension system further comprises:
a plurality of laterally disposed mechanical arms permitting movement of said seat portion in substantially a vertical direction.

10. The suspension saddle of claim 9, wherein said laterally disposed mechanical arms are spring loaded.

11. The suspension saddle of claim 6, comprising:
a front seat support arm affixed to said seat portion;
a shock absorber connected at a lower end to said front arch support and at an upper end to said front seat support arm;
wherein said front seat support arm and said seat portion are permitted to move only in a substantially vertical direction.

12. The suspension saddle of claim 6, comprising:
a front seat support arm affixed to said seat portion;
wherein said rear suspension system comprises a plurality of laterally disposed spring-loaded mechanical arms permitting movement of said seat portion in substantially a vertical direction; and
wherein said front suspension system comprises a shock absorber connected at a lower end to said front arch support and at an upper end to said front seat support arm, wherein said front seat support arm and said seat portion are permitted to move only in a substantially vertical direction.

13. A suspension saddle comprising:
a base portion;
a seat portion; and
a suspension system between and interconnecting said base portion and said seat portion, wherein the suspension system maintains the seat portion and the base portion in a spaced-apart relation to one another and allows the seat portion to move relative to the base portion.

14. The suspension saddle of claim 13, wherein
said base portion defines an upper surface;
said seat portion defines an upper surface for a seat and a lower surface facing said upper surface of said base portion;
said suspension system comprises a plurality of shock absorbers affixed to said lower surface of said seat portion and said upper surface of said base portion.

15. The suspension saddle of claim 14, wherein said shock absorbers are selected from springs, mechanical arms, flexures, hydraulic pistons, and combinations thereof.

16. The suspension saddle of claim 15, wherein said suspension system is tuned to about 100 lbf/in to about 500 lbf/in or slugs/in.

17. The suspension saddle of claim 15, wherein said suspension system is tuned to accommodate a force of about 96 to about 298 times the rider's estimated weight.

18. The suspension saddle of claim 14, wherein said suspension system comprises a plurality of compression springs capable of supporting said seat portion and a rider for independent movement, in a substantially vertical direction, with respect to the top of said base portion.

19. The suspension saddle of claim 18, wherein said seat portion is supported for independent movement above said base portion by at least three compression springs arranged and positioned for substantially vertical movement.

20. The suspension saddle of claim 18, wherein said plurality of compression springs are arranged substantially evenly along the top surface of said base portion to support the seat portion.

21. The suspension saddle of claim 18, wherein each of said base portion and seat portion define a central longitudinal arch and said plurality of compression springs are disposed symmetrically about the central arch.

22. The suspension saddle of claim 14, wherein said suspension system comprises a plurality of laterally disposed flexure arms supporting said seat portion above said base portion for vertical movement with respect thereto.

23. The suspension saddle of claim 22, wherein each of said plurality of laterally disposed flexure arms is affixed to one of said base portion or said seat portion, and moveable affixed to the other of said base portion or said seat portion.

24. The suspension saddle of claim 22, wherein said plurality of laterally disposed flexure arms is affixed to said base portion, and moveably affixed to said seat portion to facilitate movement of said seat portion with respect to the base portion.
